(19) United States
(12) Patent Application Publication
(10) Pub. No.: US 2026/0078808 A1
(43) Pub. Date: Mar. 19, 2026

(54) Disc Brake for a Utility Vehicle

(71) Applicant: KNORR-BREMSE Systeme fuer Nutzfahrzeuge GmbH, Muenchen (DE)

(72) Inventors: Martin PLEINTINGER, Eichendorf (DE); Maximilian MUENSTERER, Rossbach (DE); David ABEBE, Muenchen (DE); Bernhard PAUKNER, Muenchen (DE)

(21) Appl. No.: 19/110,593

(22) PCT Filed: Aug. 29, 2023
(86) PCT No.: PCT/EP2023/073693

§ 371 Date: Mar. 11, 2025

(30) Foreign Application Priority Data
Sep. 14, 2022 (DE) 10 2022 123 484.3

(51) Int. Cl. F16D 55/226; F16D 55/00; F16D 65/00; F16D 65/097; F16D 127/02

(52) U.S. Cl. CPC F16D 55/226; F16D 65/0056; F16D 65/0068; F16D 65/097; F16D 2055/0008; F16D 2055/0029; F16D 2127/02; F16D 2200/0021

(57) ABSTRACT

A disc brake for a utility vehicle has a brake disc, a brake caliper which engages over the brake disc and is in the form of a sliding caliper, a stationary brake carrier to which the brake caliper is secured, brake pads which each have a pad support plate and a friction lining secured thereto and which are located on either side of the brake disc in the brake caliper and which can be pressed against opposite sides of the brake disc, and a restoring device having at least one restoring spring that acts on the pad support plates of the brake pads in order to actively retract the brake pads resting on the brake disc after a braking operation. End regions of the at least one restoring spring act on the pad support plates of the brake pads so as to exert torque.

### BACKGROUND AND SUMMARY

The present invention relates to a disc brake for a utility vehicle.

In the event of a braking operation by means of a pneumatically actuable or electric-motor-actuable application device on a sliding caliper disc brake, an action-side brake pad is pressed against a brake disc. In the further course of the braking operation, the brake caliper is moved relative to the brake disc counter to the application direction of the action-side brake pad, while taking along the opposite, reaction-side, brake pad and pressing it against the other side of the brake disc.

After the release of the brake, the brake caliper in the case of the known disc brake remains in this position, in which the brake pads, but at least the reaction-side brake pad, rest against the brake disc, rubbing against it, although without pressure.

The residual friction torques of the brake pads which occur as a result during driving have a disadvantageous effect since they lead to increased fuel consumption and premature wear of the components involved, namely the brake disc and the brake pads. Admittedly, the brake pads are also released by the driving process. However, this is not always enough to prevent said residual friction torques in a sufficiently effective manner.

The prior art has already disclosed various solutions to counteract this problem. One example that may be mentioned here is DE 10 2019 131 840 A1, in which spring legs of a restoring device are held by their ends against opposite brake pads and, as a result, the brake pads resting on both sides of a brake disc after a braking operation has taken place are reliably released from the brake disc.

It is the object of the invention to further develop a disc brake of the type in question in such a way that the restoring springs for active retraction of the brake pads resting against the brake disc after a braking operation are further improved in respect of their being secured on the brake pads and in respect of expanded functionality.

This object is achieved by a disc brake having the features of the independent claim(s).

The disc brake according to the invention for a utility vehicle has a brake disc, a brake caliper, designed as a sliding caliper, fitting over the brake disc, a fixed brake carrier, on which the brake caliper is secured, and brake pads, which each have a pad carrier plate and a friction pad secured thereon, are located on either side of the brake disc in the brake caliper, and can be pressed against opposite sides of the brake disc.

The brake caliper has a central opening above the brake disc, which is spanned by a pad holding strap, securing the brake pads in a pad well of the brake carrier.

An action-side brake pad can be pressed against the brake disc by means of an application device, by way of at least one brake piston, and a reaction-side brake pad can be pressed against it by way of the brake caliper.

The disc brake furthermore has a restoring device having at least one restoring spring that acts on the pad carrier plates of the brake pads in order to actively retract the brake pads resting on the brake disc after a braking operation.

In this case, the end regions of this at least one restoring spring are designed in such a way that they act on the pad carrier plates of the brake pads, exerting a torque that is axial and/or tangential with respect to the axis of rotation of the brake disc.

The design of this interface between the end regions of the restoring spring and the two pad carrier plates in such a way that an axial and/or tangential tilting moment is thereby exerted on the pad carrier plates has the advantage of more robust fastening of the restoring spring on the pad carrier plates.

Moreover, a tilting moment exerted in this way on the brake pad causes a tilting moment on the brake pad which contributes to a reduction in oblique wear.

Advantageous variant embodiments of the invention form the subject matter of the dependent claims.

According to an advantageous variant embodiment, the restoring device has two such restoring springs. In this case, the restoring springs are preferably arranged in a region close to the lateral edges of the pad carrier plates.

According to another advantageous variant embodiment, the at least one restoring spring has a base portion, two limbs, which are angled relative to the base portion, and end regions, which are bent over relative to the limbs.

In this case, a first end region projects into a socket of the pad carrier plate of the action-side brake pad, and a second end region of the restoring spring projects into a socket of the pad carrier plate of the reaction-side brake pad.

In this case, the longitudinal axes of the end regions are aligned at an acute angle to the longitudinal axes of the sockets of the pad carrier plates.

The acute-angled alignment of the longitudinal axes of the end regions of the restoring spring relative to the longitudinal axes of the sockets of the pad carrier plates allows a defined point contact location between the end regions of the restoring spring and the sockets of the pad carrier plates, thereby increasing the friction coefficient between the mutually contacting components in an advantageous way in comparison with a parallel arrangement.

According to an advantageous further development, the sockets in the pad carrier plates are open to a radially outer front edge of the pad carrier plates.

This allows particularly easy installation of the restoring springs in the sockets of the pad carrier plates.

According to another advantageous further development, the sockets in the pad carrier plates have a recess which extends at an angle to the longitudinal axis of the sockets and into which a cranked portion of the end regions of the restoring spring projects.

A further improvement in the retention of the restoring spring in the sockets of the pad carrier plates is thereby achieved.

According to another preferred embodiment, the longitudinal axes of the end regions of the restoring spring or the longitudinal axes of the sockets of the pad carrier plates, in which the end regions of a restoring spring are received, are aligned in such a way as to taper toward or away from one another when viewed in the direction of the axis of rotation of the brake disc.

Depending on requirements, it is possible in this way to reduce oblique wear of the friction pads of the brake pads by appropriate inclination of the radially upper or lower edge of the brake pad away from the brake disc.

According to an alternative variant embodiment, the longitudinal axes of the end regions of the restoring spring or the longitudinal axes of the sockets of the pad carrier plates, in which the end regions of a restoring spring are received, are aligned parallel to one another when viewed in the direction of the axis of rotation of the brake disc.

According to another preferred variant embodiment, an inner wall delimiting the sockets in the pad carrier plates is provided with at least one groove.

The formation of such a groove in the sockets also allows an increased friction coefficient between the mutually contacting components.

According to another preferred variant embodiment, a supporting contour, which, in the installled state of the restoring spring, rests on a border of the pad carrier plate surrounding an entry to the respective socket, projects from the lateral surface of the end regions of the restoring spring.

By means of such a supporting contour, a defined penetration depth of the end regions of the restoring spring is ensured.

According to another advantageous variant embodiment of the invention, the base portion of the restoring spring is supported in the installled state on an underside of the pad holding strap, said underside facing the axis of rotation of the brake disc.

The restoring spring(s) is (are) preferably produced from a spring steel wire, in particular one with a round cross section.

Polygonal cross sections of the restoring spring are also contemplated.

Preferred exemplary embodiments of the invention are explained in greater detail below with reference to the appended drawings.

### BRIEF DESCRIPTION OF THE DRAWINGS

FIG. 1 is an isometric illustration of one variant embodiment of a disc brake according to the invention with ends of two restoring springs engaging on pad carrier plates of brake pads;

FIG. 2 is an illustration corresponding to FIG. 1 of the disc brake with the pad holding strap omitted;

FIG. 3 is an isometric isolated illustration of the two brake pads and of the restoring springs arranged thereon;

FIG. 4 is a sectional view of the brake pads with end regions of one of the restoring springs, said end regions projecting into the sockets of the pad carrier plates, with end regions of the restoring spring which are aligned so as to taper away from one another when viewed in the direction of the axis of rotation of the brake disc;

FIG. 5 is a sectional view through the disc brake in the same plane as FIG. 4 with end regions of the restoring spring which are aligned parallel to one another;

FIG. 6 is an illustration corresponding to FIG. 4 with end regions of the restoring spring which taper toward one another when viewed in the direction of the axis of rotation of the brake disc;

FIG. 7 is a sectional view through the action-side brake pad to illustrate a tangentially and obliquely set end region of one of the restoring springs in a socket of the pad carrier plate; and

FIG. 8 is an illustration similar to FIG. 7 with a vertically formed end region of the restoring spring and a socket in the pad carrier plate which is oblique in the tangential direction.

### DETAILED DESCRIPTION OF THE DRAWINGS

In the following description of the figures, terms such as top, bottom, left, right, front, rear, etc. refer exclusively to the exemplary illustration and position of the disc brake, brake disc, brake pad, pad carrier plate, restoring spring and the like selected in the respective figures. These terms are not to be understood as restrictive, i.e. these references may change due to different working positions or mirror-symmetrical design or the like.

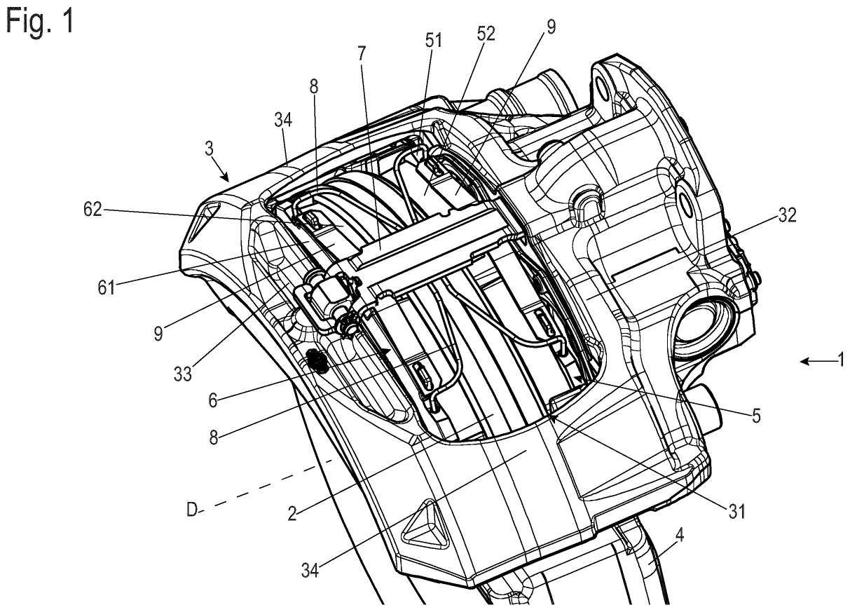

In FIG. 1, the reference sign 1 overall denotes one variant embodiment of a disc brake 1 according to the invention for a utility vehicle. The disc brake 1 has a brake disc 2 and a brake caliper 3 fitting over the brake disc 2. The brake disc 2 rotates with a wheel (not illustrated here) of a vehicle during driving. A brake disc axis of rotation D therefore coincides with the wheel axis in the installled state.

The brake caliper 3 is connected to a brake carrier 4 in such a way as to be movable axially with respect to the brake disc axis of rotation D in the direction of the brake disc axis of rotation D, for which purpose the brake caliper 1 is mounted on guide bars (not illustrated), which are connected to the brake carrier 4, which is held in a fixed location on the utility vehicle. During driving, the brake disc rotates in a circumferential direction.

The brake caliper 3 comprises an application portion 32, a caliper back 33 and two tension struts 34. The application portion 32 accommodates an application device (not illustrated) of the disc brake 1. One side of the application portion 32 runs parallel to the plane of the brake disc 2 on one side of the brake disc 2. The caliper back 33 is arranged on the other side of the brake disc 2-likewise running parallel to the brake disc 2.

The caliper back 33 is connected to the application portion 32 at each end by a respective tension strut 34. In this case, the tension struts 34 run substantially at right angles to the application portion 32 and to the caliper back 33. In this arrangement, the application portion 32, the caliper back 33 and the tension struts 34 define between them a central opening 31 which spans the brake disc 2.

The opening 31 has an imaginary longitudinal center line which lies in the plane of the brake disc 2 and connects the imaginary centers of the tension struts 34. In addition, the opening 31 has a further imaginary transverse center line, which connects an imaginary center of the application portion 32 to an imaginary center of the caliper back 33. The longitudinal center line and the transverse center line intersect at an imaginary central point, which is referred to here as the virtual center of the central opening 34. The longitudinal center line and the transverse center line thus span an imaginary plane of the central opening 31 which is radial with respect to the brake disc 2.

Brake pads 5, 6 are inserted in the brake carrier 4 and, during a braking operation, these can be pressed against the brake disc 2 on both sides. The respective brake pad 5, 6 has a brake carrier plate 51, 61 and a friction pad 52, 62, which is mounted on said plate on the side facing the brake disc 2 and is pressed against the brake disc 2 during a braking operation.

The brake pads 5, 6 can be reached through the central opening 31 for exchange and maintenance. They can be inserted into their associated pad wells in the brake carrier 4, and removed again, through the central-approximately rectangular-opening 31. The pad wells are each bounded laterally by what are referred to as “brake carrier horns” of the brake carrier 4.

During a braking operation, a brake lever, which can be arranged in a dome of the brake caliper 3, acts on an application device, which is arranged in the application portion 32 of the brake caliper 3.

During this process, the action-side or, alternatively, the application-side brake pad 5 is the first to make contact with the brake disc 2. As the application process progresses, the brake caliper 3 is moved in the opposite direction by reaction forces that arise, taking along the reaction-side brake pad 6 until the latter likewise comes into frictional contact with the brake disc 2 and thus brakes the wheel with which the brake disc 2 is rotating and therefore brakes the utility vehicle.

After the brake is released, the two opposite brake pads 5, 6 are released from the brake disc 2 by a restoring device to such an extent that the brake pads 5, 6 are no longer in contact with it.

The restoring device has at least one restoring spring 8, which develops its force effect while acting counter to the application direction.

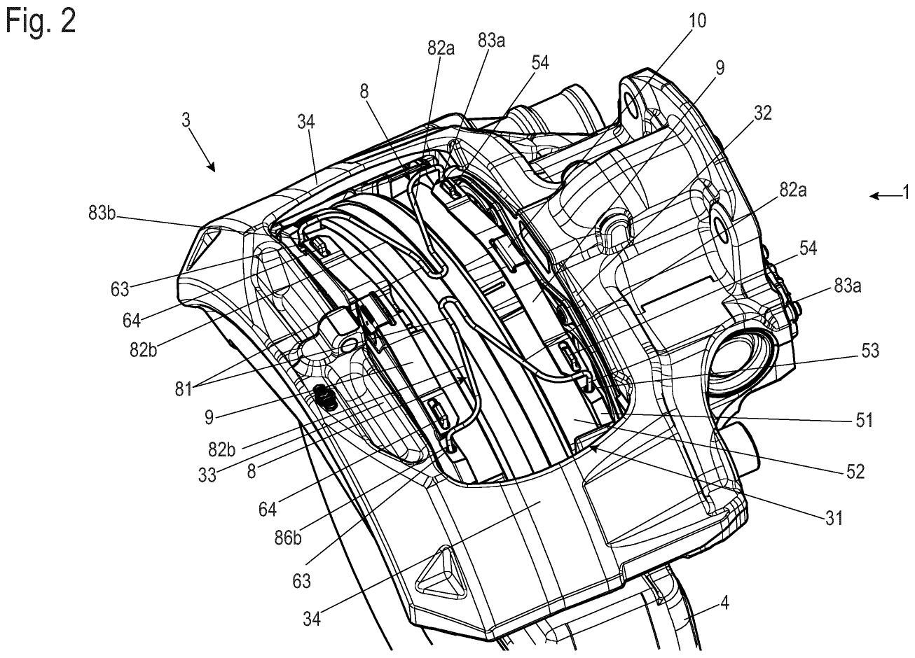

As shown in FIGS. 1 and 2, the restoring device of the disc brake 1 has two restoring springs 8. Both restoring springs 8 are preferably configured as common parts.

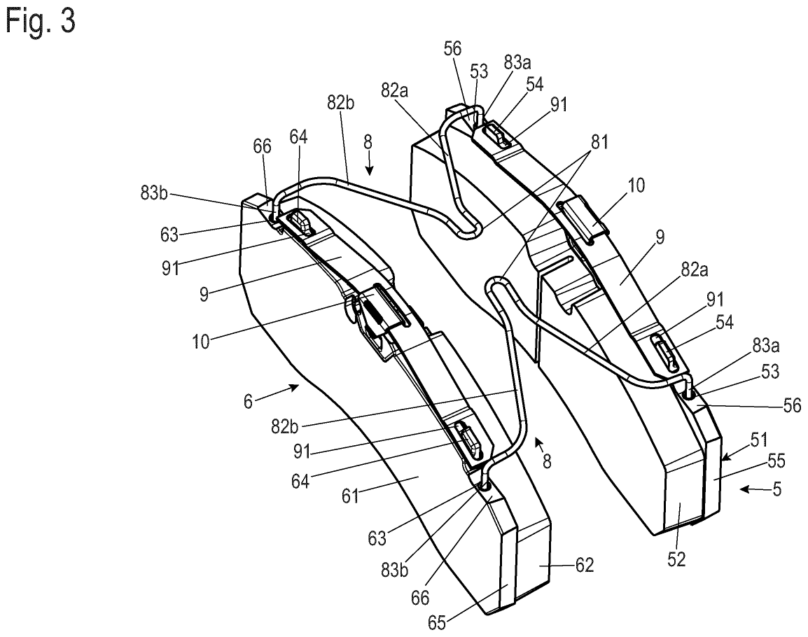

As can be seen especially in FIG. 3, which shows the two brake pads 5, 6 with restoring springs 8 arranged thereon, each of the restoring springs 8 has approximately U-shaped base portion 81, from each of the mutually parallel ends of which there extends a limb 82a, 82b angled with respect thereto.

Each of the limbs 82a, 82b has a rectilinear region and a curved region, with the result that the ends of the angled limbs 82a, 82b are aligned approximately parallel to the axis of rotation D of the brake disc 2.

Extending from each of these angled limbs 82a, 82b there is a bent-over end region 83a, 83b, which extends into a socket 53, 63 in a radially outer front edge 56, 66 of the pad carrier plate 51, 61.

In this case, the cross section of the sockets 53, 63 is slightly larger than the cross section of the end regions 83a, 83b of the restoring spring 8. Here, “slightly larger” should be understood to mean a difference in the diameter of, preferably, 10-50 percent.

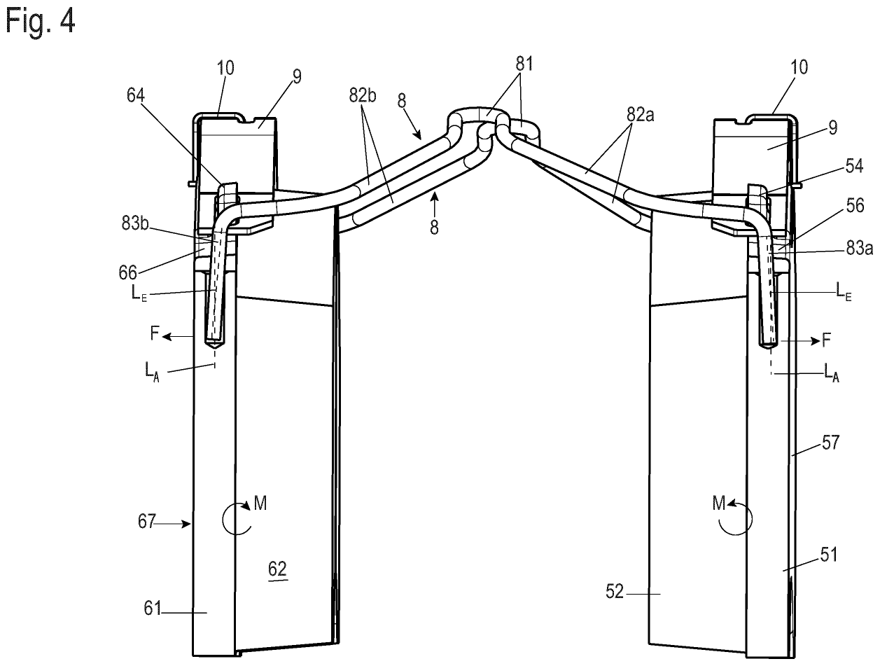

The differently dimensioned diameters enable the longitudinal axes L_{E} of the end regions 83a, 83b to be aligned at an acute angle to longitudinal axes L_{A} of the sockets 53, 63 of the pad carrier plates 51, 61, as illustrated in FIGS. 4-8 .

In the case of the variant embodiment shown in FIG. 4, the longitudinal axes L_{E} of the end regions 83a, 83b of the restoring springs 8 are aligned in such a way as to taper away from one another when viewed in the direction of the axis of rotation D of the brake disc 2. In this case, the sockets 53, 63 in the pad carrier plates 51, 61 are aligned parallel to the contact pressure surface 57, 67 of the respective pad carrier plate 51, 61.

By virtue of this acute-angled alignment of the end regions 83a, 83b relative to the sockets 53, 63, the restoring springs 8, in addition to their main task of pushing the two brake pads 5, 6 away from the brake disc 2 after a braking operation has taken place, exert a tilting moment M, by means of which the two brake pads 5, 6 are aligned with one another in such a way that a brake pad upper edge of the brake pads 5 which is radially remote from the axis of rotation D of the brake disc 2 is held slightly closer to the brake disc 2 than a brake pad lower edge of the brake pads 5, 6 which is radially closer to the axis of rotation D of the brake disc 2.

Furthermore, owing to the alignment of the end regions 83a, 83b of the restoring springs 8 which is shown in FIG. 4, the force F with which the restoring springs 8 push the two brake pads 5, 6 apart is introduced close to a center of gravity of the brake pad when viewed in the radial direction.

In addition, the use of two such restoring springs 8, which engage in the tangential direction close to the lateral edges 55, 65 of the pad carrier plates 51, 61, has the effect that the force resulting from these two restoring springs 8 likewise acts close to or even at the center of gravity of the brake pad, in this case when viewed in the tangential direction.

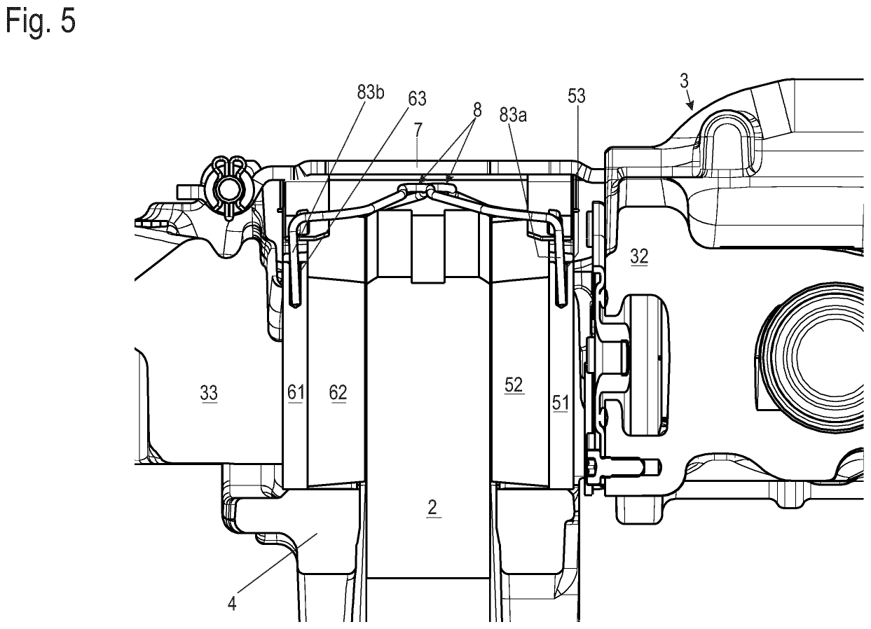

Depending on the direction of the radial oblique wear of the brake pads 5, 6, which is partially due to the design, it is also contemplated, as illustrated by way of example in FIG. 5, to align the longitudinal axes of the end regions 83a, 83b of the restoring spring 8 parallel to one another when viewed in the direction of the axis of rotation D of the brake disc 2.

This is associated, in the variant embodiment shown in FIG. 5, with the action-side brake pad causing the brake pad lower edge to tilt away from the brake disc 2 on account of the effect of the force of the restoring springs 8, while the reaction-side brake pad 6 causes the brake pad upper edge to tilt away from the brake disc 2 on account of the tilting moment applied by the restoring springs 8.

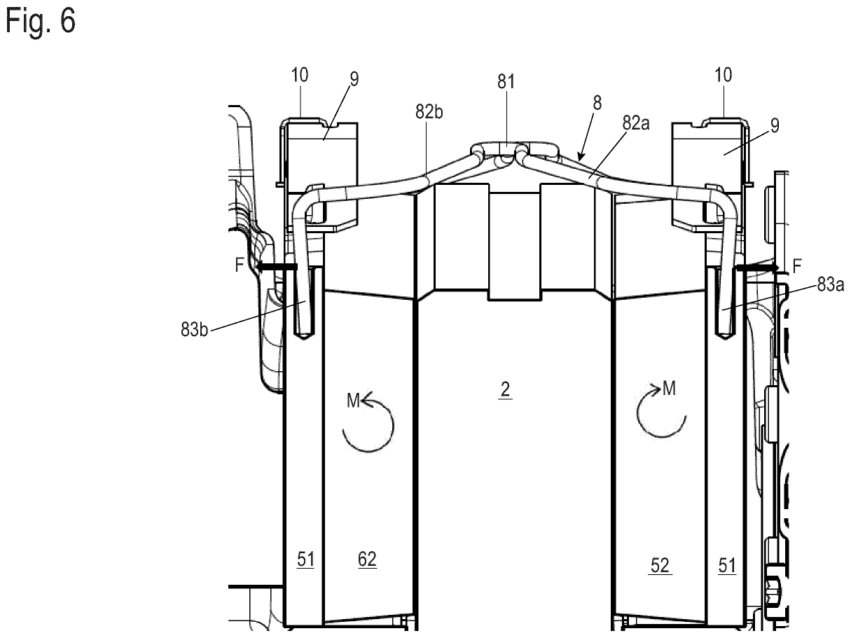

FIG. 6 shows another variant embodiment, in which the longitudinal axes L_{E} of the end regions 83a, 83b of the restoring springs 8 are aligned in such a way as to taper toward one another when viewed in the direction of the axis of rotation D of the brake disc 2, with the result that, in this case, the tilting moment M caused by the restoring springs 8 will tip both the action-side brake pad 5 and the reaction-side brake pad 6 in such a way that the brake pad upper edge is made to tilt away from the brake disc 2.

By means of the contact of the end regions 83a, 83b with inner edge regions remote from the brake disc 2 at the entry of the respective socket 53, 63, a greater tilting moment is furthermore brought about in comparison with the exemplary embodiment shown in FIG. 4 on account of the height of the point of engagement of the end region 83a, 83b of the restoring spring 8 on the entry of the socket 53, 63 of the pad carrier plate 51, 61.

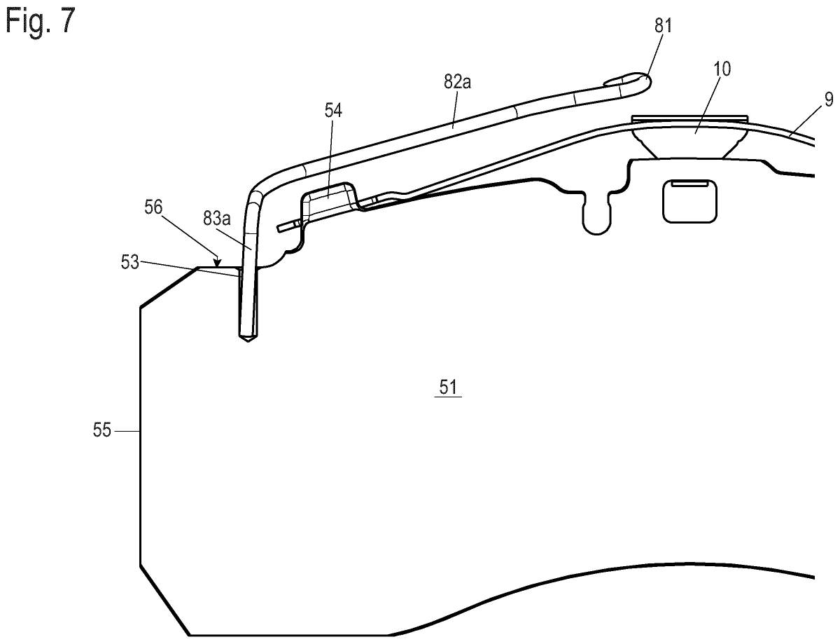

In the variant embodiment shown in FIG. 7, the longitudinal axes L_{E} of the end regions 83a, 83b of the restoring springs 8 are aligned in such a way that the acute-angled arrangement between the end regions 83a, 83b of the restoring springs 8 and the sockets 53, 63 is angled in the tangential direction.

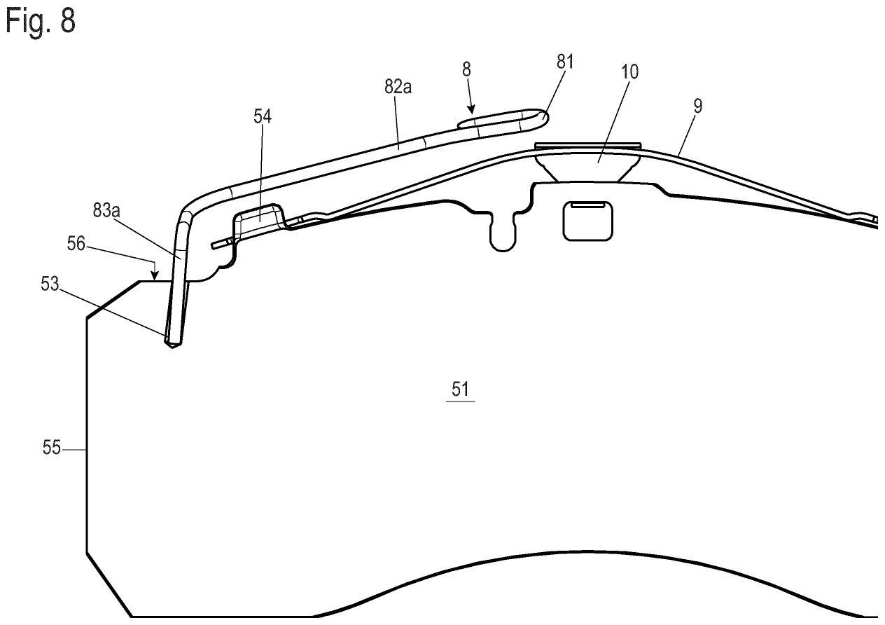

FIG. 8 shows, by way of example, a kinematic reversal of the acute-angled alignment between the end regions 83a, 83b of the restoring spring 8 and the sockets 53, 63 in the pad carrier plates 51, 61, in which the longitudinal axes L_{E} of the end region 83a of the restoring spring 8 is aligned almost vertically, while the socket 53 in the pad carrier plate 51 is designed to slope in the direction of the lateral edge 55.

The same kinematic reversal is also contemplated for the variant embodiments shown in FIGS. 4-6, wherein the formation of oblique holes in the pad carrier plate 51, 61 from the plane parallel to the contact pressure surface 57, 67 of the pad carrier plates 51, 61 is subject to narrower limits than when forming an oblique hole of the kind illustrated in the exemplary embodiment in FIG. 8.

In all the exemplary embodiments shown in the figures, the sockets 53, 63 in the pad carrier plates 51, 61 are introduced in a border region of the pad carrier plates 51, 61 which is close to the lateral edges 55, 65 when viewed in the tangential direction.

In this case, the sockets 53, 63 are preferably provided tangentially outside respective noses 54 of the pad carrier plates 51, said noses serving to guide pad holding springs 9, which, in the variant embodiment of the disc brake 1 shown here are secured on the pad carrier plate 51, 61 of the respective brake pad 5, 6 by means of clips 10, which are arranged centrally when viewed in the tangential direction.

To secure the restoring springs 8 even more on the pad carrier plates 51, 61, provision can be made for the sockets 53, 63 in the pad carrier plates 51, 61 to have a recess which extends at an angle to the longitudinal axis L_{A} of the sockets 53, 63 and into which a cranked portion of the end regions 83a, 83b of the restoring springs 8 projects.

It is also contemplated that an inner wall delimiting the sockets 53, 63 in the pad carrier plates 51, 61 has one or more grooves, by means of which the frictional engagement between the end regions 83a, 83b of the restoring springs 8 in the sockets 53, 63 of the pad carrier plates 51, 61 is further increased.

It is also contemplated that a supporting contour, which, in the installled state of the restoring spring 8, rests on a border of the pad carrier plate 51, 61 surrounding an entry to the respective socket 53, 63, projects from the lateral surface of the end regions 83a, 83b of the restoring springs 8.

The restoring springs 8 are preferably produced from a spring wire, in particular one with a round cross section. Restoring springs 8 with a different cross section, e.g. a polygonal cross section, are also conceivable. This is made possible in a simple manner, in particular, by the fact that the cross section of the end regions 83a, 83b of the restoring spring 8 is smaller than the cross section of the sockets 53, 63 in the pad carrier plates 51, 61.

### LIST OF REFERENCE SIGNS

1 disc brake
2 brake disc
21, 22 friction surface
3 brake caliper
31 opening
32 application portion
33 caliper back
4 brake carrier
41 pad well
5 action-side brake pad
51 pad carrier plate
52 friction pad
53 socket
54 nose
55 lateral edge
56 upper edge
57 contact pressure surface
6 reaction-side brake pad
61 pad carrier plate
62 friction pad
63 socket
64 nose
65 lateral edge
66 upper edge
67 contact pressure surface
7 pad holding strap
8 restoring spring
81 base portion
   82a first leg
82b second leg
83a first end region
83b second end region
9 pad holding spring
10 clip
D axis of rotation
L_{E} longitudinal axis of the end of the restoring spring
L_{A} longitudinal axis of the recess of the pad carrier plate
F force
M tilting moment

1-11. (canceled)

12. A disc brake for a utility vehicle, comprising:
a brake disc;
a brake caliper, designed as a sliding caliper, fitting over the brake disc;
a fixed brake carrier, on which the brake caliper is secured;
brake pads, which each have a pad carrier plate and a friction pad secured thereon, located on either side of the brake disc in the brake caliper, and pressable against opposite sides of the brake disc,
wherein the brake caliper has a central opening above the brake disc, which central opening is spanned by a pad holding strap, securing the brake pads in a pad well of the brake carrier,
wherein an action-side one of the brake pads is pressable against the brake disc via an application device, by way of at least one brake piston, and a reaction-side one of the brake pads is pressable against the brake disc by way of the brake caliper; and
a restoring device comprising at least one restoring spring that acts on the pad carrier plates of the brake pads in order to actively retract the brake pads resting on the brake disc after a braking operation,
wherein end regions of the at least one restoring spring act on the pad carrier plates of the brake pads, exerting a torque that is axial and/or tangential with respect to the axis of rotation of the brake disc.

13. The disc brake as claimed in claim 12, wherein the restoring device comprises two restoring springs.

14. The disc brake as claimed in claim 13, wherein
the at least one restoring spring has a base portion, two limbs which are angled relative to the base portion, and the end regions, which end regions are bent over relative to the limbs,
a first end region projects into a socket of the pad carrier plate of the action-side brake pad, and
a second end region projects into a socket of the pad carrier plate of the reaction-side brake pad, and
longitudinal axes of the end regions are aligned at an acute angle to longitudinal axes of the sockets of the pad carrier plates.

15. The disc brake as claimed in claim 14, wherein the sockets in the pad carrier plates are open to a radially outer front edge of the pad carrier plates.

16. The disc brake as claimed in claim 14, wherein
the sockets in the pad carrier plates have a recess which extends at an angle to the longitudinal axis of the sockets and into which a cranked portion of the end regions of the restoring spring projects.

17. The disc brake as claimed in claim 14, wherein
the longitudinal axes of the end regions of the restoring spring or the longitudinal axes of the sockets of the pad carrier plates, in which the end regions of a restoring spring are received, are aligned so as to taper toward or away from one another when viewed in the direction of the axis of rotation of the brake disc.

18. The disc brake as claimed in claim 14, wherein the longitudinal axes of the end regions of the restoring spring or the longitudinal axes of the sockets of the pad carrier plates, in which the end regions of a restoring spring are received, are aligned parallel to one another when viewed in the direction of the axis of rotation of the brake disc.

19. The disc brake as claimed in claim 14, wherein an inner wall delimiting the sockets in the pad carrier plates is provided with at least one groove.

20. The disc brake as claimed in claim 14, wherein a supporting contour, which, in an installled state of the restoring spring, rests on a border of the pad carrier plate surrounding an entry to the respective socket, projects from the lateral surface of the end regions of the restoring spring.

21. The disc brake as claimed in claim 14, wherein
the base portion of the restoring spring is supported in an installled state on an underside of the pad holding strap, said underside facing the axis of rotation of the brake disc.

22. The disc brake as claimed in claim 14, wherein
the restoring spring is produced from a spring steel wire.

23. The disc brake as claimed in claim 22, wherein
the restoring spring is produced from a spring steel wire with a round cross section.
